(19) United States
(12) Patent Application Publication
(10) Pub. No.: US 2010/0071370 A1
(43) Pub. Date: Mar. 25, 2010

(54) RENEWABLE ENERGY RECOVERY FROM MSW AND OTHER WASTES

(76) Inventor: Pearse O'Kane, Dublin (IE)

Correspondence Address: CHOATE, HALL & STEWART LLP, TWO INTERNATIONAL PLACE, BOSTON, MA, 02110, US

(21) Appl. No.: 12/444,500

(22) PCT Filed: Oct. 6, 2006
(86) PCT No.: PCT/EP06/67164

§ 371 Date: Dec. 7, 2009

(51) Int. Cl. F01K 9/00; B03B 9/00; C10L 5/40; C10L 1/00; B01J 10/00; F02B 73/00

(52) U.S. Cl. 60/685; 48/126; 48/197 FM; 44/307; 422/187; 60/698

(57) ABSTRACT

Raw MSW is delivered through an organic digester (12) within which an organic fraction of the MSW is broken down by a combination of aerobic microbial activity and mechanical action and converted into a solid bio fuel material. Treated waste material comprising a mixture of the solid bio fuel material and insert inorganic waste material is discharged from the digester (12). The treated material is delivered through a separator (20) for removal of the inorganic fraction. A substantially homogenous solid bio fuel material is discharged from the separator (20), and passed through a dryer (26) and into a gasifier (30). Within the gasifier (30) the homogenous solid bio fuel material is heated in a depleted oxygen atmosphere to generate a bio fuel gas rich in methane, hydrogen and carbon monoxide. The bio fuel gas is delivered through a cleaner (35) and then collected in a storage tank. Bio fuel gas is fed as required from the storage tank to a power plant (50) for generating electrical energy.

### INTRODUCTION

This invention relates to the recovery of renewable energy from waste material such as Municipal Solid Waste (MSW) and other wastes, including commercial and sludge wastes.

### DESCRIPTION OF THE PRIOR ART

One long established method of handling MSW is to simply dump the waste at designated landfill sites. However, there is an ever increasing volume of MSW being generated and such landfill sites are becoming more limited. Further, waste disposed of in this manner has a negative environmental impact and presents a pollution hazard.

It is also well known to dispose of MSW and other wastes by incineration, Heat generated by combustion of the waste in the incinerator is used to generate steam which drives a steam turbine which in turn drives an electrical generator. However, whilst incineration reduces the landfill requirement it also presents environmental problems such as toxic emissions produced during the combustion process.

It is further known, for example as disclosed in U.S. Pat. No. 6,032,467, to coarsely chop-up the municipal solid waste and deliver the coarsely chopped MSW through a gasifier to generate a fuel gas which may, for example, be used to power a gas turbine. However, a problem with these methods is the widely variable calorific value of the waste material due to the heterogeneous nature of the MSW. To overcome this problem it is proposed in U.S. Pat. No. 6,032,467 to add high-grade coal to the waste to adjust the calorific value of the waste. However, this is not ideal, and one has the problems associated with trying to maintain a substantially even calorific value throughout processing by controlled addition and mixing of the coal with the waste.

In our earlier filed application-Publication No. WO2006/059316 we have disclosed a system for generating energy from MSW.

It is an object of the present invention to provide an improved process and apparatus for the efficient extraction and recovery of renewable energy from MSW.

### SUMMARY OF THE INVENTION

According to the invention there is provided a process for extracting renewable energy from waste material such as MSW and the like which comprises a mixture of organic and inorganic waste materials including:
delivering raw waste material into an organic material digester;
treating the raw waste material in the organic material digester for converting an organic fraction of the raw waste material into a solid bio fuel material which is mixed with an inert inorganic waste material fraction of the raw waste material;
discharging treated material from the organic material digester and delivering said treated material to a separator;
separating the inert inorganic waste material from the solid bio fuel material in the separator and separately discharging the inorganic material and a substantially homogenous solid bio fuel material from the separator;
downstream of the separator delivering the homogenous solid bio fuel material through a dryer for reducing the moisture content of the homogenous solid bio fuel material;
after drying subjecting the homogenous solid bio fuel material to heat treatment for extracting a fuel gas from said homogenous solid bio fuel material.

The heat treatment can be by gasification, pyrolysis, or other forms of heat treatment.

The fuel gas may be used to generate energy in a gas turbine, to drive a gas powered engine or to generate liquid bio fuels.

In one embodiment of the invention the process includes healing the homogeneous solid bio fuel material in an oxygen depleted atmosphere for extracting the fuel gas from the homogeneous solid bio fuel material.

In one embodiment the process includes recirculating heat generated during heat treatment of the homogenous solid bio fuel material through the dryer for drying the homogenous solid bio fuel material prior to heat treatment of the homogenous solid bio fuel material.

In another embodiment the process includes using the fuel gas to generate energy in a gas powered engine. The gas powered engine may, for example, be provided by a gas turbine.

In a further embodiment the process includes liquefying the fuel gas to produce a liquid bio fuel.

In another embodiment the process includes screening the solid bio fuel material for extracting any particles sized greater than 25 mm.

In another embodiment the process includes delivering exhaust gas discharged from the gas powered engine through a steam generator for generating steam.

In a further embodiment the process includes delivering the steam to a steam turbine for driving the steam turbine, the steam turbine driving an electrical generator for generating electrical power.

In another embodiment the process includes cleaning the fuel gas.

In another embodiment the process includes collecting condensate during fuel gas production and delivering the condensate through a treatment plant to remove impurities.

In a further embodiment the process includes passing the homogenous solid bio fuel material through a destoning apparatus upstream of the dryer.

In another embodiment the process includes baling the inert inorganic material discharged from the separator.

In another embodiment the process includes feeding the inert inorganic material discharged from the separator through gasification, pyrolysis or other forms of heat treatment for energy recovery.

In another embodiment the process includes extracting metal material from the inert inorganic material discharged from the separator.

In another aspect the invention provides a system for extracting renewable energy from waste material such as MSW and the like, including:
an organic material digester having an inlet for charging the digester with waste material and a treated material outlet, said digester being operable to convert an organic fraction of waste material delivered into the digester into a solid bio fuel material;
a separator having means for separating the solid bio fuel material from an inert inorganic fraction of treated material discharged from the digester;
a dryer for drying the solid bio fuel material discharged from the separator; and
heat treatment apparatus having means for heat treatment of the solid bio fuel material for generating a fuel gas from said solid bio fuel material.

In one embodiment the heat treatment apparatus has means for heating the solid bio fuel material in an oxygen depleted atmosphere for extracting the fuel gas from the solid bio fuel material.

In another embodiment means is provided for recirculating heat generated in the heat treatment apparatus through the dryer for drying the solid bio fuel material.

In another embodiment the apparatus further includes a gas powered engine and means for supplying the fuel gas to said gas powered engine.

In another embodiment the gas powered engine is drivably connected to an electrical generator.

In another embodiment the system includes a steam generator and means for delivering exhaust gases from the gas powered engine through the steam generator.

In another embodiment the system includes a steam turbine connected to the steam generator for reception of steam therefrom to drive the steam turbine.

In another embodiment the steam turbine is drivably connected to an electrical generator.

In a further embodiment the system includes a cleaner for cleaning the fuel gas generated in the heat treatment apparatus.

In another embodiment the system includes means for liquefying the fuel gas to produce a liquid bio fuel.

In another embodiment the system includes means for heat treatment of the inorganic waste material discharged from the separator for generating energy from the inorganic waste material.

### BRIEF DESCRIPTION OF THE DRAWINGS

The invention will be more clearly understood from the following description of some embodiments thereof, given by way of example only, with reference to the accompanying drawings, in which:

FIG. 1 is a schematic illustration of a process for extracting renewable energy from MSW according to the invention;

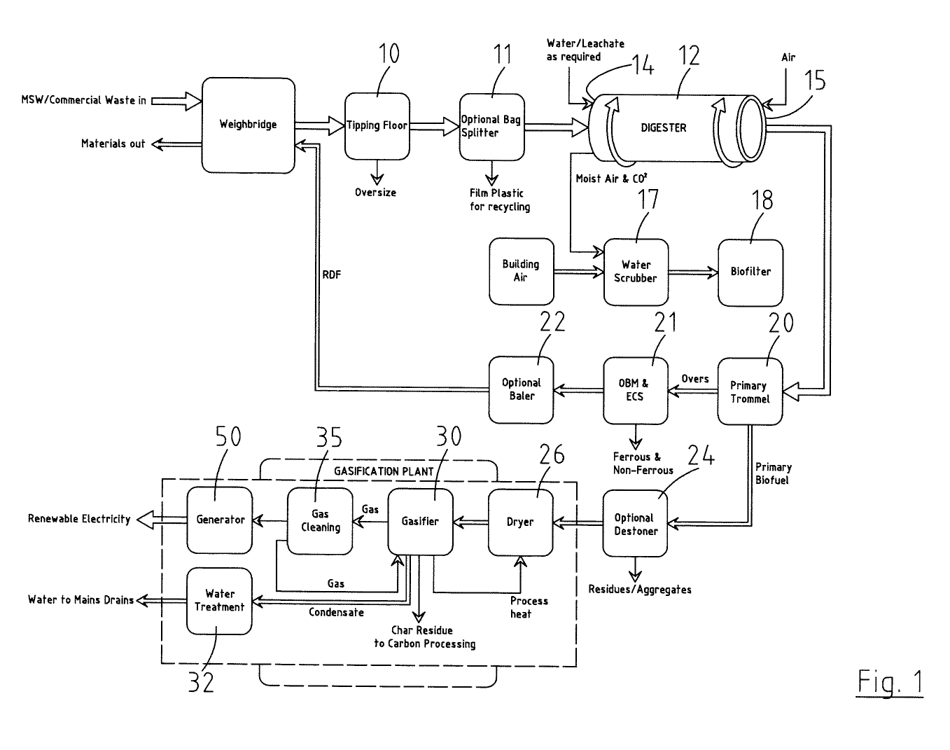

FIG. 2 is a schematic illustration of a renewable energy generating plant used in the process; and

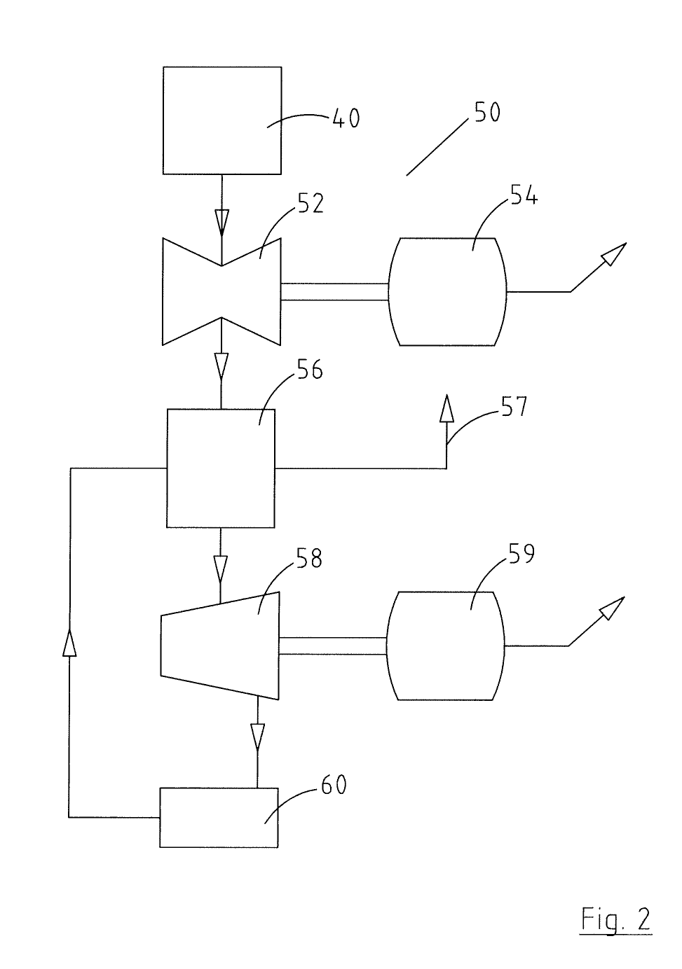

FIG. 3 is a schematic perspective view of a rotary organic digester used in the process.

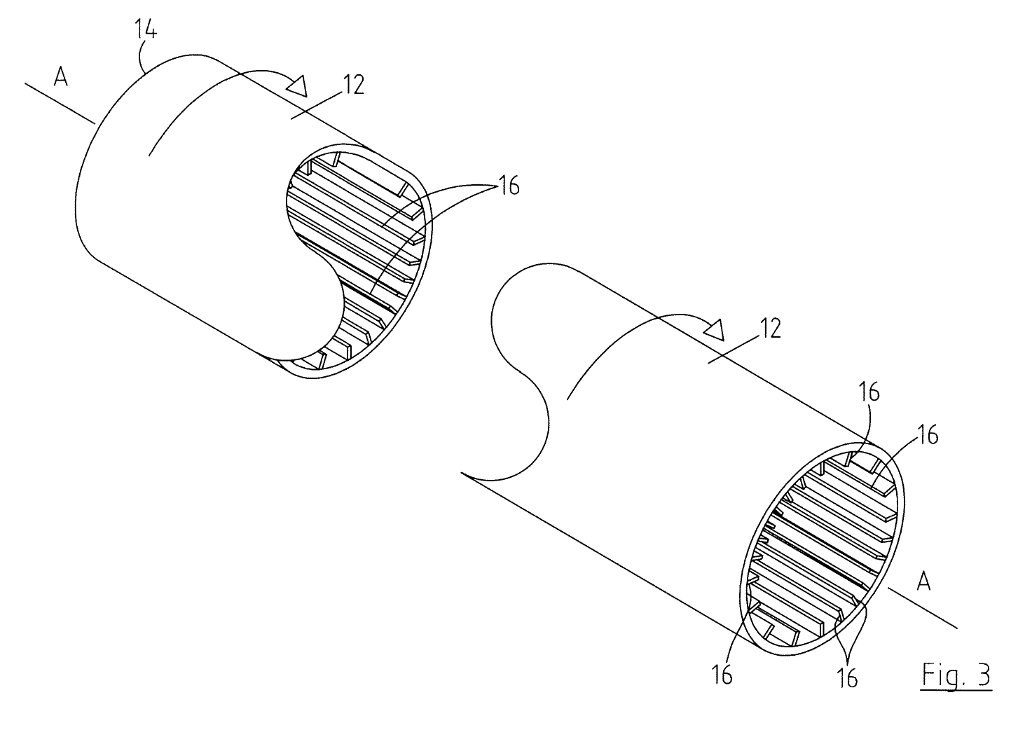

### DETAILED DESCRIPTION OF PREFERRED EMBODIMENTS

Referring to the drawings MSW is delivered onto a tipping floor 10 which has sufficient storage space for up to two days of waste collection. Any oversized items are removed from the MSW at this stage.

The MSW is then delivered into a rotary organic digester 12. The MSW may optionally be passed through a bag splitter 11 for removal of plastic film material prior to delivery to the digester 12.

The digester 12 is essentially an elongate cylindrical steel drum 12 which is rotated about a central axis A of the drum 12 which is generally horizontal with a small downward tilt between an inlet end 14 and an outlet end 15 of the drum 12. An inner wall surface of the drum 12 is provided with a series of ribs 15 extending between opposite ends 14, 15 of the drum 12 parallel to the drum central axis A and mounted spaced-apart around an entire inside circumference of the drum 12. These ribs 16 protect the drum 12 side wail and contain inoculant material between the ribs 16. Baffles may optionally be provided within the drum 12 to help regulate the flow of material through the drum 12. Other suitable digesters are described in WO2006/059316, U.S. Pat. No. 5,047,349 and U.S. Pat. No. 5,407,809 for example.

As the MSW passes through the drum 12, typically over a period of about 2 days, an organic fraction of the MSW is broken down by a combination of aerobic microbial activity and mechanical activity as the waste tumbles through the drum 12 between the inlet 14 and outlet 15 of the digester drum 12. During treatment air is delivered through the drum 12 and moist air and carbon dioxide generated within the drum are extracted and delivered through a water scrubber 17 and biofilter 18. The organic fraction of the MSW is converted in the drum 12 into a solid bio fuel material. Treated waste material comprising a mixture of the solid bio fuel material and inert inorganic waste material is discharged from the outlet 15 of the digester drum 12.

This treated material is then fed to a separator 20 for separating the inert inorganic waste materiel from the solid bio fuel material. The inert inorganic waste material discharged from the separator 20 may optionally be delivered through a baler 22 and transported away for further processing or recycling. Prior to baling metals may be recovered in a metal extractor 21. A substantially homogenous solid bio fuel material is separately discharged from the separator 20. This material has a typical particle size of less than 5 mm and moisture content of 45%-55%.

The homogeneous solid bio fuel material is optionally passed through a destoner 24 and into a dryer 26. Within the dryer 26 the moisture content of the homogenous solid bio fuel material is reduced. At the inlet the moisture content may be as high as 70%, however more typically the moisture content will be in the order of 45% 55% and generally will be about 48%.

The homogenous solid bio fuel material which has been dried is then delivered to a gasifier 30. Within the gasifier 30, the homogenous solid bio fuel material is heated in an oxygen depleted atmosphere. This prevents the formation of pollutants such as dioxins and Wrens associated with conventional combustion, Gasification of the homogenous solid bio fuel material is initiated in the gasifier 30 when it is heated to about 450° C. (about 842° F.) at which point exothermic reactions provide sufficient heat to drive the temperature higher and sustain the reactions. During normal operation the heat required to initiate the gasification process is derived from gas generated and stored during previous operation. The healing of the homogenous solid bio fuel material in the depleted oxygen atmosphere generates a bio fuel gas rich in methane, hydrogen and carbon monoxide. The gasification process of the invention produces a fuel gas with a minimum of liquids, solids and minimal pollution. The by-products are a small char residue, and if the material used is moist water will also be produced which can be treated 32 before disposal.

Bio fuel gases are passed through a cleaner 35 which includes a particle remover to ensure a clean stream of biogas fuel. The cleaned biogas is then cooled to remove water and any liquid fuels from it. Clean bio fuel gas is then delivered to a pressurised storage tank 40.

The bio fuel gases are than converted into electrical energy in a power plant indicated generally by the reference numeral 50. Bio fuel gas is delivered from the storage tank 40 to a gas turbine 52. Energy extracted from the bio fuel gas drives the gas turbine which in turn drives an electrical generator 54 for generating electrical power. Energy extraction from the bio fuel gas within the gas turbine 52 occurs at such high temperatures, typically greater than 1300° C. (2.400° F.) that any traces of dioxins and furans are completely destroyed.

Exhaust gases from the gas turbine 52 are delivered through a steam generator 56 before discharge through a flue 57. Heat recovered from the exhaust gases in the steam generator 56 is used for the generation of steam which is delivered through a steam turbine 58 which in turn drives another electrical generator 59 for further generation of electrical power. Steam discharged from the turbine 58 is delivered through a condenser 60 within which it is condensed into feed water which is returned through the steam generator 56.

It will be appreciated that depending on the composition of the MSW, relatively high amounts of clean energy can be produced from the bio fuel gas or the gas can be liquefied to produce bio fuels, such as bio-ethanol and/or bio-diesel.

It will also be appreciated that the process of the invention provides an efficient process for the conversion of MSW and other wastes into renewable energy. Waste handling is simplified by feeding the MSW directly through the organic digester. A substantially homogeneous solid bio fuel material is extracted from the treated waste discharged from the digester for delivery through the gasifier.

The invention is not limited to the embodiments hereinbefore described which may be varied in both construction and detail within the scope of the appended claims.

1. A process for extracting renewable energy from waste material such as MSW and the like which comprises a mixture of organic and inorganic waste materials including:
delivering raw waste material into an organic material digester;
treating the raw waste material in the organic material digester for converting an organic fraction of the raw waste material into a solid bio fuel material which is mixed with an inert inorganic waste material fraction of the raw waste material;
discharging treated material from the organic material digester and delivering said treated material to a separator;
separating the inert inorganic waste material from the solid bio fuel material in the separator and separately discharging the inorganic material and a substantially homogenous solid bio fuel material from the separator;
downstream of the separator delivering the homogenous solid bio fuel material through a dryer for reducing the moisture content of the homogenous solid bio fuel material;
after drying subjecting the homogenous solid bio fuel material to heat treatment for extracting a fuel gas from said homogenous solid bio fuel material.

2. A process as claimed in claim 1 wherein the process includes heating the homogeneous solid bio fuel material in an oxygen depleted atmosphere for extracting the fuel gas from the homogeneous solid bio fuel material.

3. A process as claimed in claim 1 wherein the process includes recirculating heat generated during heat treatment of the homogenous solid bio fuel material through the dryer for drying the homogenous solid bio fuel material prior to heat treatment of the homogenous solid bio fuel material.

4. A process as claimed in claim 1 wherein the process includes using the fuel gas to generate energy in a gas powered engine.

5. A process as claimed in claim 1 wherein the process includes liquefying the fuel gas to produce a liquid bio fuel.

6. A process as claimed in claim 1 wherein the process includes screening the solid bio fuel material for extracting any particles sized greater than 25 mm.

7. A process as claimed in claim 1 wherein the process includes delivering exhaust gas discharged from the gas powered engine through a steam generator for generating steam.

8. A process as claimed in claim 7 wherein the process includes delivering the steam to a steam turbine for driving the steam turbine, the steam turbine driving an electrical generator for generating electrical power.

9. A process as claimed in claim 1 wherein the process includes cleaning the fuel gas.

10. A process as claimed in claim 1 wherein the process includes collecting condensate during fuel gas production and delivering the condensate through a treatment plant to remove impurities.

11.-14. (canceled)

15. A system for extracting renewable energy from waste material such as MSW and the like, including:
an organic material digester having an inlet for charging the digester with waste material and a treated material outlet, said digester being operable to convert an organic fraction of waste material delivered into the digester into a solid bio fuel material;
a separator having means for separating the solid bio fuel material from an inert inorganic fraction of treated material discharged from the digester;
a dryer for drying the solid bio fuel material discharged from the separator; and
heat treatment apparatus having means for heat treatment of the solid bio fuel material for generating a fuel gas from said solid bio fuel material.

16. A system as claimed in claim 11 wherein the heat treatment apparatus has means for heating the solid bio fuel material in an oxygen depleted atmosphere for extracting the fuel gas from the solid bio fuel material.

17. A system as claimed in claim 15 wherein means is provided for recirculating heat generated in the heat treatment apparatus through the dryer for drying the solid bio fuel material.

18. A system as claimed in claim 15 wherein the apparatus further includes a gas powered engine and means for supplying the fuel gas to said gas powered engine.

19. A system as claimed in claim 14 wherein the gas powered engine is drivably connected to an electrical generator.

20. A system as claimed in claim 18 wherein the system includes a steam generator and means for delivering exhaust gases from the gas powered engine through the steam generator.

21. A system as claimed in claim 16 wherein the system includes a steam turbine connected to the steam generator for reception of steam therefrom to drive the steam turbine.

22. A system as claimed in claim 17 wherein the steam turbine is drivably connected to an electrical generator.

23. A system as claimed in claim 15 wherein the system includes a cleaner for cleaning the fuel gas generated in the heat treatment apparatus.

24. A system as claimed in claim 15 wherein the system includes means for liquefying the fuel gas to produce a liquid bio fuel.

25. (canceled)
